(19) United States
(12) Patent Application Publication
(10) Pub. No.: US 2001/0047456 A1
(43) Pub. Date: Nov. 29, 2001

(54) Processor

(76) Inventors: Thomas Schrobenhauzer, Kanagawa (JP); Eiji Iwata, Kanagawa (JP)

Correspondence Address: Charles P. Sammut, Attorney at law, 350 Woodside Avenue, Mill Valley, CA, 94941-3822, US

(21) Appl. No.: 09/761,630

(22) Filed: Jan. 17, 2001

(30) Foreign Application Priority Data
Jan. 28, 2000 (JP) P2000-024829

(51) Int. Cl. G06F 12/00

(52) U.S. Cl. 711/122; 711/154

(57) ABSTRACT

A processor capable of processing a large amount of data such as image data at a high speed with a small scale and a low manufacturing cost, wherein a data buffer memory has a first storage region for storing stream data and a second storage region for storing picture data and inputs and outputs the stream data between the first storage region and a CPU by a FIFO method; the sizes of the first storage region and the second storage region can be changed based on a value of a control register; and data other than the image data is transferred via a second cache memory and a data cache memory between the CPU and an external memory.

### BACKGROUND OF THE INVENTION

1. Field of the Invention

The present invention relates to a processor preferred for the case of processing bit stream data in a central processing unit (CPU).

2. Description of the Related Art

In a conventional general processor, for example, as shown in FIG. 1, an instruction cache memory 101 and data cache memory 102, a second level cache memory 103, and an external memory (main storage apparatus) 104 are successively provided hierarchically in order from the one nearest to a CPU 100.

Instruction codes of programs to be executed in the CPU 100 are stored in the instruction cache memory 101. Data used at the time of execution of the instruction codes in the CPU 100 and data obtained by the related execution etc. are stored in the data cache memory 102.

In the processor shown in FIG. 1, transfer of the instruction codes from the external memory 104 to the instruction cache memory 101 and transfer of the data between the external memory 104 and the data cache memory 102 are carried out via the second level cache memory 103.

Summarizing the problem to be solved by the invention, in the processor shown in FIG. 1, however, when handling a large amount of data such as image data, since the related data is transferred between the CPU 100 and the external memory 104 via both of the second level cache memory 103 and the data cache memory 102, it is difficult to transfer the related data between the CPU 100 and the external memory 104 at a high speed.

Further, in the processor shown in FIG. 1, when handling a large amount of the data such as image data, there is a high possibility of traffic in a cache bus. It becomes further difficult to transfer the related data between the CPU 100 and the external memory 104 at a high speed due to this.

Further, the data cache memory 102 first decides that it does not itself store data requested by the CPU 100, then requests the related data from the second level cache memory 103, so there is a disadvantage that the waiting time of the CPU 100 becomes long.

Further, in the conventional processor, sometimes where a first-in-first-out (FIFO) memory is provided between the second level cache memory 13 and the external memory 14, but the capacity and the operation of the related FIFO are fixed, so there is insufficient flexibility. Further, there is a disadvantage in that the chip size and total cost become greater if an FIFO circuit is included in the chip.

### SUMMARY OF THE INVENTION

An object of the present invention is to provide a processor capable of processing a large amount of data such as image data at a high speed with a small size and low manufacturing costs.

In order to achieve the above object, according to a first aspect of the present invention, there is provided a processor comprising an operation processing circuit for performing operation processing using data and stream data, a first cache memory for inputting and outputting said data with said operation processing circuit, a second cache memory interposed between a main storage apparatus and said first cache memory, and a storage circuit interposed between said main storage apparatus and said operation processing circuit and having at least part of a storage region outputting said stream data in the order of input.

In the processor of the first aspect of the present invention, the operation processing circuit performs predetermined processing, and the data required in the process of the related processing is input and output between the first cache memory and the operation processing circuit.

The related data is transferred between the main storage apparatus and the operation processing circuit via the first cache memory and the second cache memory.

Alternatively, in the processor of the first aspect of the present invention, the operation processing circuit performs predetermined processing, and the stream data required in the related processing step is input and output between the storage circuit and the operation processing circuit.

The input and output of the data between the storage circuit and the operation processing circuit are carried out by the FIFO system of output in the order of input.

The related storage circuit is interposed between the operation processing circuit and the main storage apparatus. The stream data is transferred between the operation processing circuit and the main storage apparatus without interposition of the second cache memory.

Further, in the processor of the first aspect of the present invention, preferably said storage circuit outputs said stream data in the order of the input by successively increasing or decreasing an address accessed by said operation processing circuit.

Further, in the processor of the first aspect of the present invention, preferably said storage circuit manages the storage region for outputting said stream data in the order of the input by dividing it to at least a first storage region and a second storage region, transfers data between said second storage region and said main storage apparatus when the operation processing circuit accesses said first storage region, and transfers data between said first storage region and said main storage apparatus when said operation processing circuit accesses said second storage region.

Further, in the processor of the first aspect of the present invention, preferably said stream data is bit stream data of an image, and said storage circuit stores picture data in a storage region other than the storage region for storing said bit stream data.

Further, in the processor of the first aspect of the present invention, preferably said storage circuit can change the sizes of the storage region for storing said stream data and the storage region for storing said picture data.

Further, in the processor of the first aspect of the present invention, preferably further comprises a DMA circuit for controlling the transfer of said stream data between said storage circuit and said main storage apparatus.

Further, in the processor of the first aspect of the present invention, preferably, when a plurality of accesses simultaneously occur with respect to the related storage circuit, said storage circuit sequentially performs processing in accordance with the related plurality of accesses based on a priority order determined in advance.

Further, in the processor of the first aspect of the present invention, preferably said storage circuit is a one-port type memory.

According to a second aspect of the present invention, there is provided a processor comprising an operation processing circuit for executing an instruction code and performing operation processing using data and stream data according to need, a first cache memory for supplying said instruction code to said operation processing circuit, a second cache memory for input and output of said data with said operation processing circuit, a third cache memory interposed between the main storage apparatus and said first cache memory and said second cache memory, and a storage circuit interposed between said main storage apparatus and said operation processing circuit and having at least part of a storage region outputting said stream data in an order of the input.

### BRIEF DESCRIPTION OF THE DRAWINGS

These and other objects and features of the present invention will become clearer from the following description of the preferred embodiments given with reference to the attached drawings, in which:

FIG. 1 is a view of the configuration of a conventional processor;

FIG. 2 is a view of the configuration of a processor according to an embodiment of the present invention;

FIG. 3 is a view for explaining a function of a data buffer memory shown in FIG. 2;

FIG. 4 is a view for explaining the function of the data buffer memory shown in FIG. 2;

FIG. 5 is a flowchart showing an operation in a case where bit stream data is read from the data buffer memory to a CPU shown in FIG. 2;

FIG. 6A to 6C are views for explaining the operation shown in FIG. 5; and

FIG. 7 is a flowchart showing the operation in a case where the bit stream data is written into the data buffer memory from the CPU shown in FIG. 2.

### DESCRIPTION OF THE PREFERRED EMBODIMENTS

Below, an explanation will be made of a processor according to a preferred embodiment of the present invention.

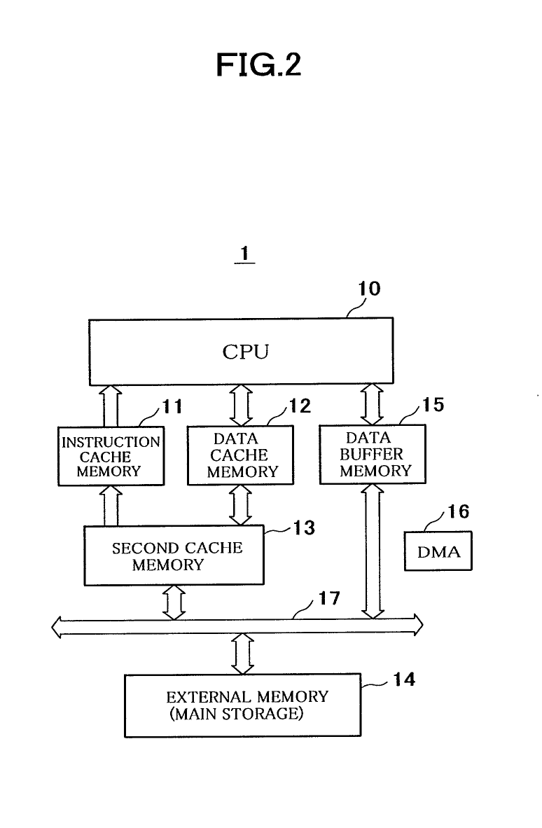

FIG. 2 is a view of the configuration of a processor 1 of the present embodiment.

As shown in FIG. 2, the processor 1 has for example a CPU 10, an instruction cache memory 11, a data cache memory 12, a second cache memory 13, an external memory 14, a data buffer memory 15, and a direct memory access (DMA) circuit 16.

Here, the CPU 10, instruction cache memory 11, data cache memory 12, second cache memory 13, data buffer memory 15, and the DMA circuit 16 are provided on one semiconductor chip.

Note that, the CPU 10 corresponds to the processor of the present invention, the data buffer memory 15 corresponds to the storage circuit of the present invention, and the external memory 14 corresponds to the main storage apparatus of the present invention.

Further, the data cache memory 12 corresponds to the first cache memory of claim 1 and the second cache memory of claim 9, and the second cache memory 13 corresponds to the second cache memory of claim 1 and the third cache memory of claim 9.

Further, the instruction cache memory 11 corresponds to the first cache memory of claim 9.

The CPU 10 performs a predetermined operation based on instruction codes read from the instruction cache memory 11.

The CPU 10 performs predetermined operation processing by using the data read from the data cache memory 12 and the bit stream data or the picture data input from the data buffer memory 15 according to need.

The CPU 10 writes the data of the result of the operation processing into the data cache memory 12 according to need and writes the bit stream data or the picture data of the result of the operation into the data buffer memory 15 according to need.

The CPU 10 performs predetermined image processing using the data input from the data buffer memory 15 and the bit stream data or the picture data input from the data cache memory 12 based on the instruction code input from the instruction cache memory 11.

Here, as the image processing performed by the CPU 10 using the bit stream data, there are encoding and decoding of the MPEG2.

Further, the CPU 10 writes the data into a control register 20 for determining the size of the storage region functioning as the FIFO memory in the data buffer memory 15 in accordance with the execution of an application program as will be explained later.

The instruction cache memory 11 stores the instruction codes to be executed in the CPU 10. When receiving for example an access request with respect predetermined instruction codes from the CPU 10, it outputs the related instruction codes to the CPU 10 when it has already stored a page containing the related instruction codes, while outputs the related requested instruction codes to the CPU 10 after replacing a predetermined page which has been already stored with a page containing the related requested instruction codes with the second cache memory 13 when it has not stored the related instruction codes.

The page replacement between the instruction cache memory 11 and the second cache memory 13 is controlled by for example the DMA circuit 16 operating independently from the processing of the CPU 10.

The data cache memory 12 stores the data to be used at the time of execution of the instruction codes in the CPU 10 and the data obtained by the related execution. When receiving for example an access request with respect to predetermined data from the CPU 10, it outputs the related data to the CPU 10 when it has already stored the page containing the related data, while outputs the related requested data to the CPU 10 after replacing a predetermined page which has been already stored with the page containing the related requested data with the second cache memory 13 when it has not stored the related data.

The page replacement between the instruction cache memory 11 and the second cache memory 13 is controlled by for example the DMA circuit 16 operating independently from the processing of the CPU 10.

The second cache memory 13 is connected via the instruction cache memory 11, the data cache memory 12, and the bus 17 to the external memory 14.

When the second cache memory 13 has already stored the required page where performing the page replacement between the instruction cache memory 11 and the data cache memory 12, the related page is transferred to the instruction cache memory 11 and the data cache memory 12, while when it has not stored the required page, the related page is read from the external memory 14 via the bus 17, then the related page is transferred to the instruction cache memory 11 and the data cache memory 12.

The page transfer between the second cache memory 13 and the external memory 14 is controlled by for example the DMA circuit 16 operating independently from the processing of the CPU 10.

The external memory 14 is a main storage apparatus for storing the instruction codes used in the CPU 10, data, bit stream data, and the picture data.

The data buffer memory 15 has for example a storage region 15a functioning as a scratch-pad random access memory (RAM) for storing picture data to be subjected to motion compensation prediction, picture data before encoding, picture data after decoding, etc. when performing for example digital video compression and storage region 15b functioning as a virtual FIFO memory for storing the bit stream data. Use is made of for example a RAM.

The data buffer memory 15 is for example a one-port memory.

Here, the size of the storage region 15b functioning as the virtual FIFO memory in the data buffer memory 15 is determined in accordance with for example the value indicated by data stored in the control register 20 built in the data buffer memory 15.

In the control register 20, for example, data in accordance with the application program to be executed in the CPU 10 is stored.

Here, the size of the storage region 15b functioning as the virtual FIFO memory is determined so as to be for example a whole multiple of 8 bytes in units of 8 bytes.

Then, where the size of the storage region 15b functioning as the virtual FIFO memory is determined to be 8 bytes, 16 bytes, and 32 bytes, data indicating binaries “000”, “001”, and “010” are stored in the control register 20.

On the other hand, the storage region 15a functioning as the scratch-pad RAM becomes the storage region obtained by excluding the storage region 15b functioning as the virtual FIFO memory determined according to the data stored in the control register 20 from among all storage regions of the data buffer memory Further, the storage region 15b functioning as the virtual FIFO memory in the data buffer memory 15 is managed divided into two storage regions having the same size.

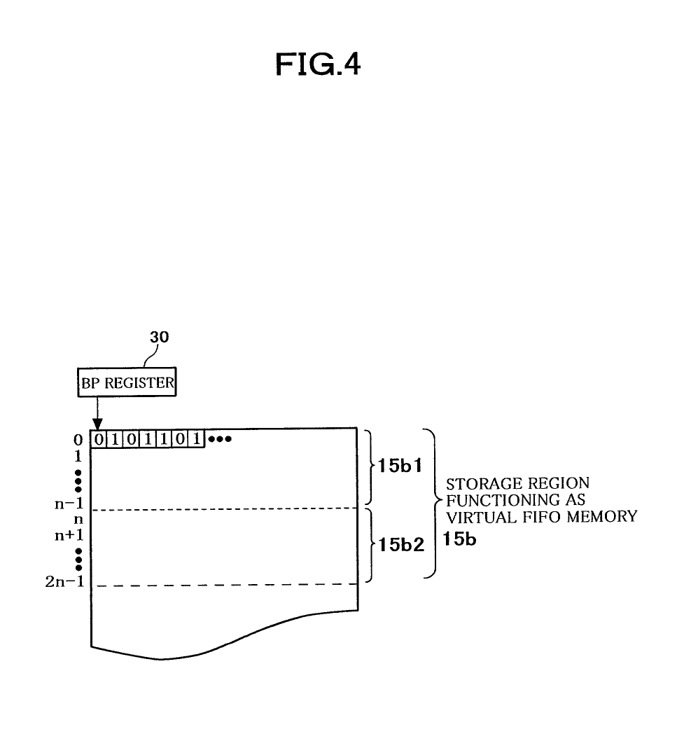

The data buffer memory 15 has, for example, as shown in FIG. 4, a bitstream pointer (BP) register 30. The BP register 30 stores an address for present access in the storage region 15b functioning as the virtual FIFO memory.

The address stored in the BP register 30 is sequentially incremented (increased) or decremented (decreased) by for example the DMA circuit 16.

For example, as shown in FIG. 4, when the data buffer memory 15 stores the bit data in cells arranged in a matrix, for example the storage region 15b functioning as the virtual FIFO memory is managed by the DMA circuit 16 while being divided to a storage region 15b1 for the “0”-th to “n−1”-th rows and a storage region 15b2 for the “n”-th to “2n−1”-th rows.

The address stored in the BP register 30 is sequentially incremented from the “0”-th row toward the “2n−1”-th row in FIG. 4, and then from the left end toward the right end in the figure in each row.

The address stored in the BP register 30 points to the address on the right end of the “2n−1”-th row (last address of the storage region 15b) in the storage region 15b2, then points to the address of the left end of the first row (starting address of the storage region 15b) in the data buffer memory 15b1.

For example, when the CPU 10 reads bit stream data from the storage region 15b at for example the time of decoding, new bit stream data is automatically transferred from the external memory 14 to the storage region 15b.

Further, when the CPU 10 writes the bit stream data in the storage region 15b at for example the time of encoding, the bit stream data is automatically transferred from the storage region 15b to the external memory 14.

The transfer of the bit stream data between the storage region 15b and the external memory 14 is carried out in the background without exerting an influence upon the processing in the CPU 10 based on the control of the DMA circuit 16.

A programmer may designate the direction of transfer of the bit stream data between the storage region 15b and the external memory 14, the address of the reading side, and the address of the destination of the write operation by using for example a not illustrated control register.

The DMA circuit 16 controls for example the page transfer between the instruction cache memory 11 and the data cache memory 12 and the second cache memory 13, the page transfer between the second cache memory 13 and the external memory 14, and the page transfer between the data buffer memory 15 and the external memory 14 independently from the processing of the CPU 10.

Where requests or requirements with respect to a plurality of processing to be performed by the DMA circuit 16 simultaneously occur, in order to sequentially process the processing in order, a queue is prepared.

Further, a predetermined priority order is assigned to access with respect to the data buffer memory 15. This priority order is determined in advance in a fixed manner.

For example, in access with respect to the data buffer memory 15, a higher priority order than the access with respect to the picture data is assigned to the access with respect to the bit stream. For this reason, the continuity of the function as an FIFO memory of the storage region 15b of the data buffer memory 15 is realized with a high probability, and the continuity of the encoding and the decoding of the bit stream data in the CPU 10 is secured with a high probability.

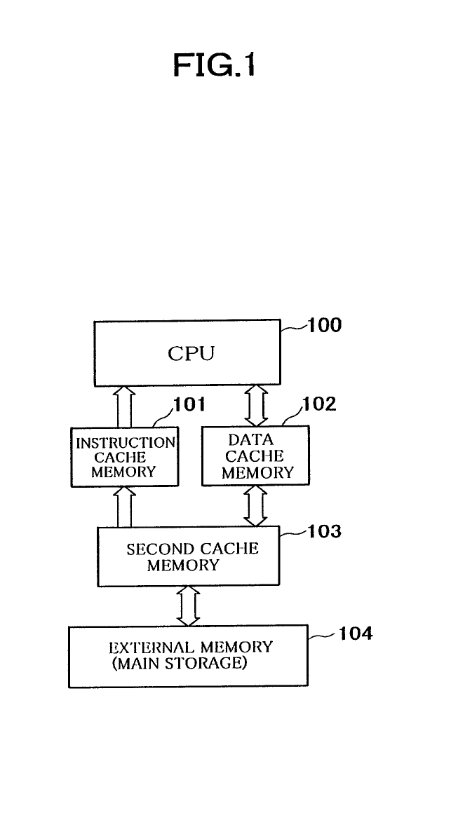

Below, an explanation will be given of examples of the operation of the processor 1 shown in FIG. 1.

### FIRST EXAMPLE OF OPERATION

In the related example of operation, the explanation will be made of the operation of the processor 1 in the case of for example in the CPU 10 shown in FIG. 1 and reading the bit stream data from the data buffer memory 15 to the CPU 10.

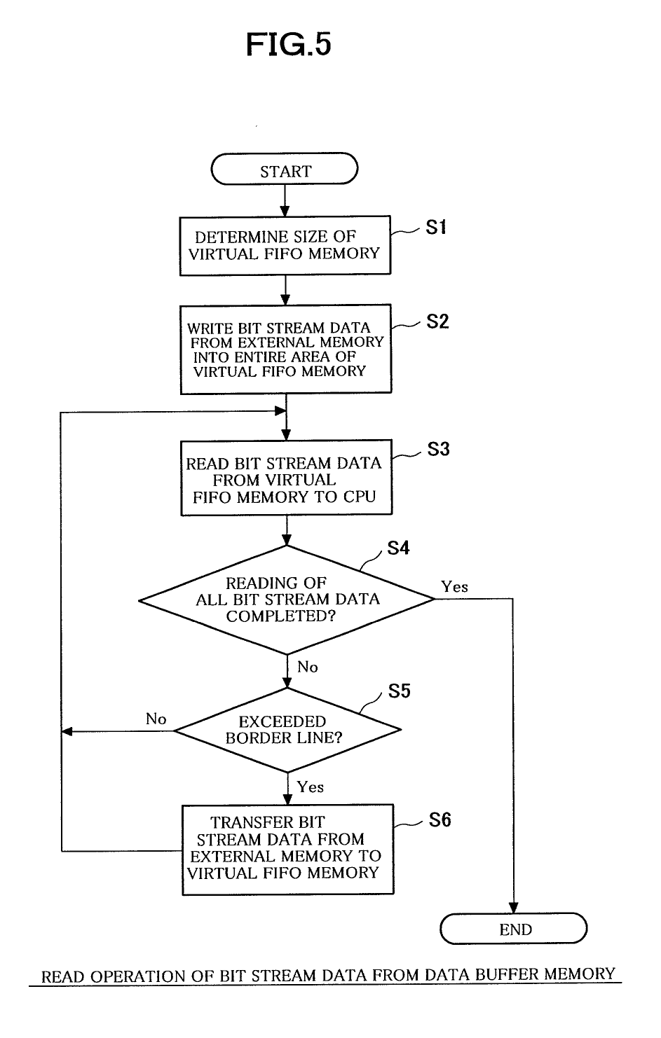

FIG. 5 is a flowchart showing the operation of the processor 1 when reading bit stream data from the data buffer memory 15 to the CPU 10.

Step S1: For example, the size of the storage region 15b functioning as the virtual FIFO memory in the data buffer memory 15 is set in the control register 20 in accordance with the execution of the application program in the CPU 10.

By this, the size of the storage region 15b functioning as the virtual FIFO memory in the data buffer memory 15 is determined.

Step S2: For example, in accordance with the execution of the application program in the CPU 10, when the not illustrated DMA circuit receives a read instruction (reading of bit stream data), it transfers the bit stream data via the bus 17 from the external memory 14 to the storage region 15b functioning as the virtual FIFO memory in the data buffer memory 15.

In this case, for example, the bit stream data is written in the entire area of the storage region 15b.

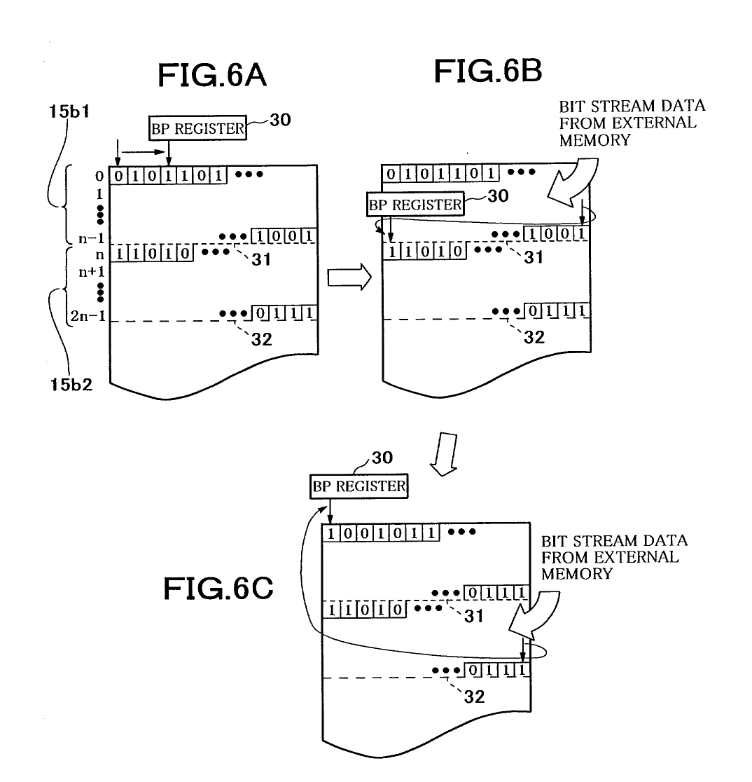

Further, the bit stream data is sequentially written into the storage region 15b in the order of reading as shown in FIG. 6A from the 0-th row toward the “2n−1”-th row and then from the left end toward the right end in the figure in each row.

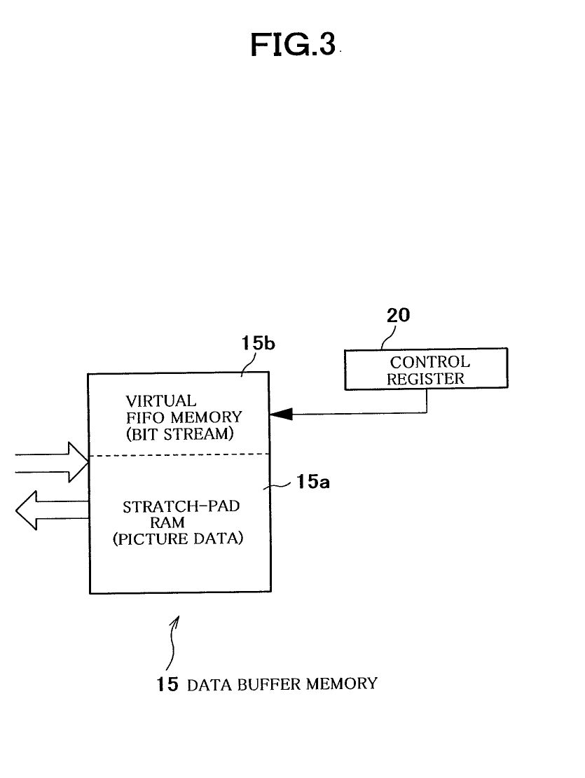

Step S3: In accordance with the progress of the decoding in the CPU 10, for example the bit stream data is read from the address of the storage region 15b in the data buffer memory 15 stored in the BP register 30 shown in FIG. 3 to the CPU 10.

The address stored in the BP register 30 is incremented in order whenever the processing of the related step S3 is executed.

The related incrementation is carried out for example from the 0-th row toward the “2n−1”-th row in FIG. 6A and then from the left end toward the right end in the figure in each row so as to point to an address in the storage region 15b.

Note that the address stored in the BP register 30 points to the address on right end in the “2n−1”-th row (last address of the storage region 15b) in the storage region 15b2, then points to the address on the left end in the first row (starting address of the storage region 15b) in the data buffer memory 15b1.

Step S4: It is decided by the DMA circuit 16 whether or not the bit stream data to be processed in the CPU 10 has all been read from the data buffer memory 15 to the CPU 10. When it has all been read, the processing is terminated, while when not all read, the processing of step S5 is executed.

Step S5: It is decided by the DMA circuit 16 whether or not the address stored in the BP register 30 has exceeded a border line 31 as shown in FIG. 6A or exceeded a border line 32 as shown in FIG. 6C. When it is decided that it has exceeded the border line, the processing of step S6 is executed, while when it is decided that it did not exceed the border line, the processing of step S3 is carried out again.

Step S6: When the address stored in the BP register 30 has exceeded the border line 31 as shown in FIG. 6B, the bit stream data is transferred via the external bus 17 from the external memory 14 to the entire area of the storage region 15b1 of the data buffer memory 15 by the DMA circuit 16.

On the other hand, where the address stored in the BP register 30 has exceeded the border line 32 as shown in FIG. 6C, the bit stream data is transferred via the external bus 17 from the external memory 14 to the entire area of the storage region 15b2 of the data buffer memory 15 by the DMA circuit 16.

When the processing of step S6 is terminated, the processing of step S3 is continuously carried out.

### SECOND EXAMPLE OF OPERATION

In this example of operation, an explanation will be made of the operation of the processor 1 in a case for example of encoding in the CPU 10 shown in FIG. 1 and writing the bit stream data from the CPU 10 into the data buffer memory 15.

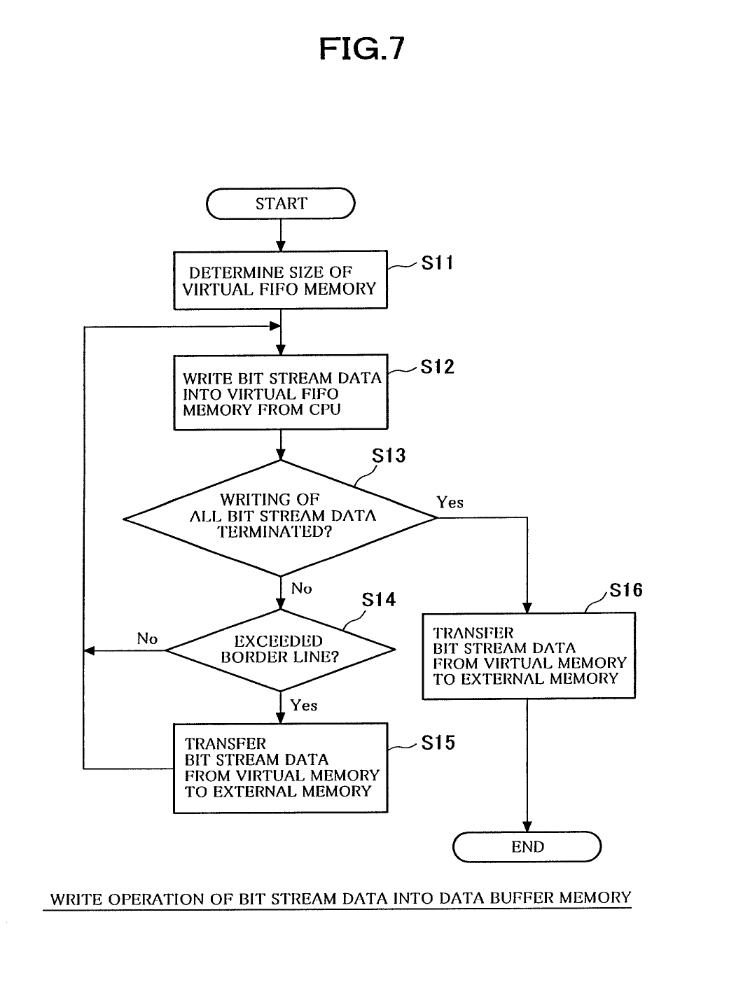

FIG. 7 is a flowchart showing the operation of the processor 1 when writing bit stream data from the CPU 10 into the data buffer memory 15.

Step S11: For example, in accordance with the execution of the application program in the CPU 10, the size of the storage region 15b functioning as the virtual FIFO memory in the data buffer memory 15 is set in the control register 20.

By this, the size of the storage region 15b functioning as the virtual FIFO memory in the data buffer memory 15 is determined.

Step S12: In accordance with the progress of the encoding in the CPU 10, for example the bit stream data is written from the CPU 10 at the address of the storage region 15b in the data buffer memory 15 stored in the BP register 30 shown in FIG. 3.

The address stored in the BP register 30 is incremented in order whenever the processing of the related step S12 is executed.

The related incrementation is carried out for example from the 0-th row toward the “2n−1”-th row in (A) FIG. 6 and then from the left end toward the right end in the figure in each row so as to point to an address in the storage region 15b.

Note that the address stored in the BP register 30 points to the address at the right end in the “2n−1”-th row (last address of the storage region 15b) in the storage region 15b2, then points to the address on the left end in the first row (starting address of the storage region 15b) in the data buffer memory 15b1.

Step S13: It is decided by the DMA circuit 16 whether or not the bit stream data processed in the CPU 10 was all written in the data buffer memory 15. When it is decided that it was all written, the processing of step S16 is carried out, while where not all written, the processing of step S14 is executed.

Step S14: It is decided by the DMA circuit 16 whether or not the address stored in the BP register 30 has exceeded a border line 31 as shown in FIG. 6B or exceeded a border line 32 as shown in FIG. 6C. When it is decided that it has exceeded the border line, the processing of step S15 is executed, while when it is decided that it did not exceed the border line, the processing of step S12 is carried out again.

Step S15: When the address stored in the BP register 30 has exceeded the border line 31 as shown in FIG. 6B, all of the bit stream data stored in the storage region 15b1 is transferred via the external bus 17 to the external memory 14 by the DMA circuit 16.

On the other hand, when the address stored in the BP register 30 has exceeded the border line 32 as shown in FIG. 6C, all of the bit stream data stored in the storage region 15b2 is transferred via the external bus 17 to the external memory 14 by the DMA circuit 16.

When the processing of step S15 is terminated, the processing of step S12 is carried out.

Step S16: This is executed when it is decided that all of the bit stream data was written from the CPU 10 into the storage region 15b at step S13. All of the bit stream data written in the storage region 15b is transferred via the external bus 17 from the data buffer memory 15 to the external memory 14 by the DMA, circuit 16.

As explained above, according to the processor 1, a large amount of image data such as bit stream data and picture data is transferred between the external memory 14 and the CPU 10 not via the data cache memory 12 and the second cache memory 13 but via only the data buffer memory 15.

As a result, it becomes possible to transfer image data between the CPU 10 and the external memory 14 at a high speed, and the continuity of the processing of the image data in the CPU 10 can be secured with a high performance.

Further, according to the processor 1, by pointing to addresses of the storage region of the data buffer memory 15 in order by using the BP register 30, the data buffer memory 15 is made to function as an FIFO memory.

As a result, it becomes unnecessary to provide an FIFO memory in the chip independently, so a reduction of the size and a lowering of the cost can be achieved.

Further, according to the processor 1, the sizes of the storage region 15a functioning as the scratch-pad RAM in the data buffer memory 15 and the storage region 15b functioning as the virtual FIFO memory can be dynamically changed by rewriting the data stored in the control register 20 in accordance with the content of the application program.

As a result, a memory environment adapted to the application program to be executed in the CPU 10 can be provided.

Further, according to the processor 1, for example in the case where the CPU 10 performs processing for continuous data or the case where the CPU 10 requests data with a predetermined address pattern, by transferring the data required by the CPU 10 from the external memory 14 to the data buffer memory 15 in advance before receiving the request from the CPU 10, the waiting time of the CPU 10 can be almost completely eliminated.

The present invention is not limited to the above embodiment.

For example, in the above embodiment, bit stream data used in image processing of the MPEG2 or the like was illustrated as the stream data, but other data can be used too as the stream data so far as it is data which is continuously sequentially processed in the CPU 10.

Summarizing the effects of the invention, as explained above, according to the present invention, a processor capable of processing a large amount of data such as image data at a high speed with a small size and inexpensive configuration can be provided.

Further, according to the present invention, a processor capable of continuously processing stream data with a small size and inexpensive configuration can be provided.

What is claimed is:

1. A processor comprising
an operation processing circuit for performing operation processing using data and stream data, a first cache memory for inputting and outputting said data with said operation processing circuit,
a second cache memory interposed between a main storage apparatus and said first cache memory, and
a storage circuit interposed between said main storage apparatus and said operation processing circuit and having at least part of a storage region outputting said stream data in the order of input.

2. A processor as set forth in claim 1, wherein said storage circuit outputs said stream data in the order of the input by successively increasing or decreasing an address accessed by said operation processing circuit.

3. A processor as set forth in claim 1, wherein said storage circuit
manages the storage region for outputting said stream data in the order of the input by dividing it to at least a first storage region and a second storage region,
transfers data between said second storage region and said main storage apparatus when the operation processing circuit accesses said first storage region, and
transfers data between said first storage region and said main storage apparatus when said operation processing circuit accesses said second storage region.

4. A processor as set forth in claim 1, wherein
said stream data is bit stream data of an image, and
said storage circuit stores picture data in a storage region other than the storage region for storing said bit stream data.

5. A processor as set forth in claim 4, wherein said storage circuit can change the sizes of the storage region for storing said stream data and the storage region for storing said picture data.

6. A processor as set forth in claim 1, further comprising a DMA circuit for controlling the transfer of said stream data between said storage circuit and said main storage apparatus.

7. A processor as set forth in claim 1, wherein, when a plurality of accesses simultaneously occur with respect to the related storage circuit, said storage circuit sequentially performs processing in accordance with the related plurality of accesses based on a priority order determined in advance.

8. A processor as set forth in claim 1, wherein said storage circuit is a one-port type memory.

9. A processor comprising
an operation processing circuit for executing an instruction code and performing operation processing using data and stream data according to need,
a first cache memory for supplying said instruction code to said operation processing circuit,
a second cache memory for input and output of said data with said operation processing circuit,
a third cache memory interposed between the main storage apparatus and said first cache memory and said second cache memory, and
a storage circuit interposed between said main storage apparatus and said operation processing circuit and having at least part of a storage region outputting said stream data in an order of the input.

10. A processor as set forth in claim 9, wherein said storage circuit outputs said stream data in the order of the input by successively increasing or decreasing an address accessed by said operation processing circuit.

11. A processor as set forth in claim 9, wherein said storage circuit
manages the storage region for outputting said stream data in the order of the input by dividing it to at least a first storage region and a second storage region,
transfers data between said second storage region and said main storage apparatus when the operation processing circuit accesses said first storage region, and
transfers data between said first storage region and said main storage apparatus when said operation processing circuit accesses said second storage region.

12. A processor as set forth in claim 9, wherein
said stream data is bit stream data of an image, and
said storage circuit stores picture data in a storage region other than the storage region for storing said bit stream data.

13. A processor as set forth in claim 12, wherein said storage circuit can change the sizes of the storage region for storing said stream data and the storage region for storing said picture data.
